(19) United States
(12) Patent Application Publication
(10) Pub. No.: US 2021/0205939 A1
(43) Pub. Date: Jul. 8, 2021

(54) LENS ASSEMBLING DEVICE AND METHOD FOR ASSEMBLING LENSES BY THE LENS ASSEMBLING DEVICE

(71) Applicant: HON HAI PRECISION INDUSTRY CO., LTD., New Taipei (TW)

(72) Inventors: LI-SHING HOU, New Taipei (TW); QING-BO WANG, Jincheng (CN)

(21) Appl. No.: 16/993,346

(22) Filed: Aug. 14, 2020

(30) Foreign Application Priority Data
Jan. 8, 2020 (CN) 202010019358.4

(51) Int. Cl. B23P 19/04; G02B 27/30; G05B 19/402

(52) U.S. Cl. CPC B23P 19/04; G02B 7/021; G05B 19/402; G02B 27/30

(57) ABSTRACT

A lens assembling device includes a collimator, a sensor, a feedback control platform located between the collimator and the sensor, a lens transfer component, and a processor electrically or signal connected to the feedback control platform, the sensor, and the lens transfer component, respectively. A method for assembling lenses by the lens assembling device is also disclosed.

### FIELD

The subject matter relates to a lens assembling device and a method for assembling lenses by the lens assembling device.

### BACKGROUND

With the development of portable electronic devices, lens modules have become more and more widely used. A lens module includes a barrel and a plurality of lenses sequentially arranged in the barrel from the object side to the image side of the lens module. The lens module needs a lens assembling device and a method for assembling lenses to improve the quality of the lens module.

### BRIEF DESCRIPTION OF THE DRAWINGS

Implementations of the present technology will now be described, by way of example only, with reference to the attached figures.

FIG. 1 is a diagrammatic view of an embodiment of a lens assembling device assembling a first lens.

FIG. 2 is a diagrammatic view of the lens assembling device of FIG. 1 assembling a second lens.

FIG. 3 is an enlarged diagrammatic view of a sensor.

FIG. 4 is a schematic diagram of a light spot center P₀ calculated by a weight average after electric current classification.

FIG. 5A is a schematic diagram showing parallel light forming a first light spot on the sensor after passing through the first lens.

FIG. 5B is a schematic diagram showing parallel light forming a second light spot on the sensor after passing through the first lens and the second lens inclined with respect to the first lens in that sequence.

FIG. 5C is a schematic diagram showing parallel light forming the second light spot on the sensor after adjusting the first lens and the second lens.

FIG. 6 is a flowchart of an embodiment of a method for assembling lenses by the lens assembling device.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

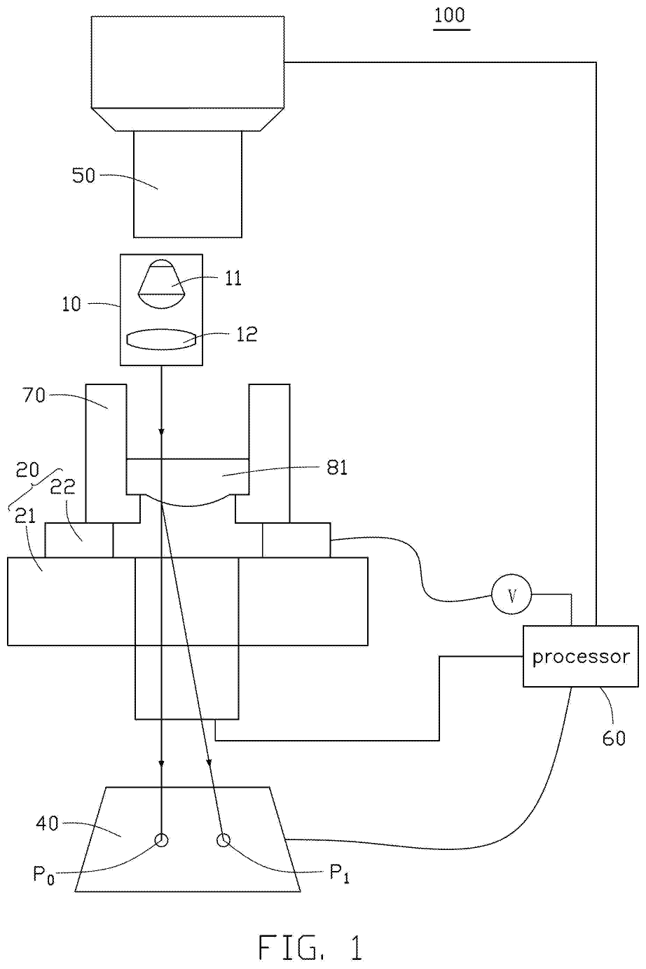

FIG. 1 illustrates an embodiment of a lens assembling device 100 used to assemble a plurality of lenses 80 in a lens barrel 70 to form a lens module.

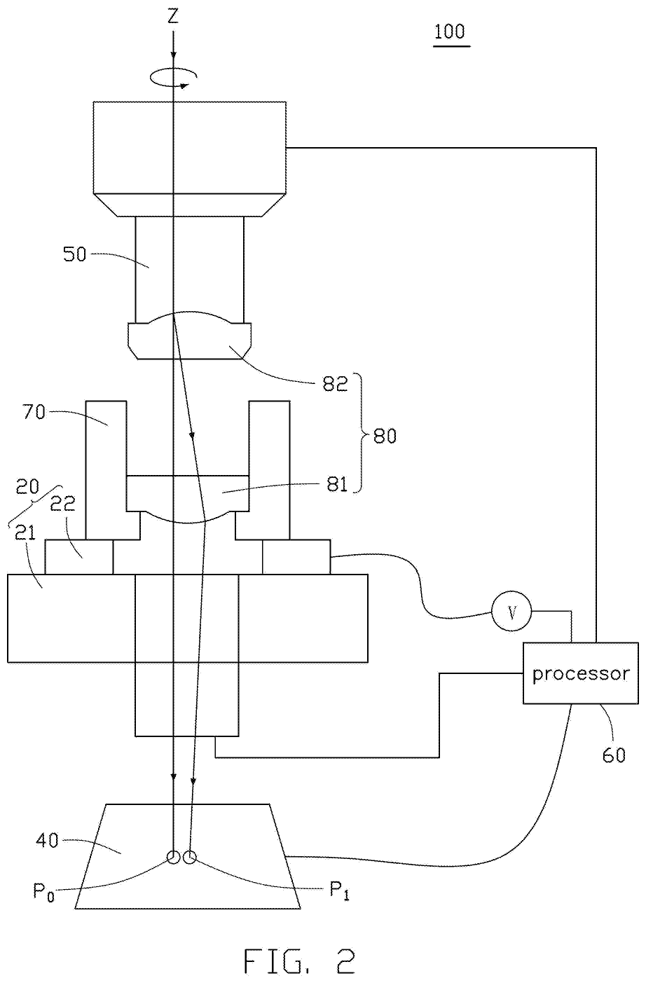

Referring to FIGS. 1 and 2, The lens assembling device 100 includes a collimator 10, a feedback control platform 20, a sensor 40, a lens transfer component 50, and a processor 60. The feedback control platform 20 is located between the collimator 10 and the sensor 40. The lens barrel 70 is fixed on the feedback control platform 20 and located between the collimator 10 and the feedback control platform 20. The lens transfer component 50 is located on a side of the lens barrel 70. The processor 60 is electrically or signal connected to the feedback control platform 20, the sensor 40, and the lens transfer component 50, respectively.

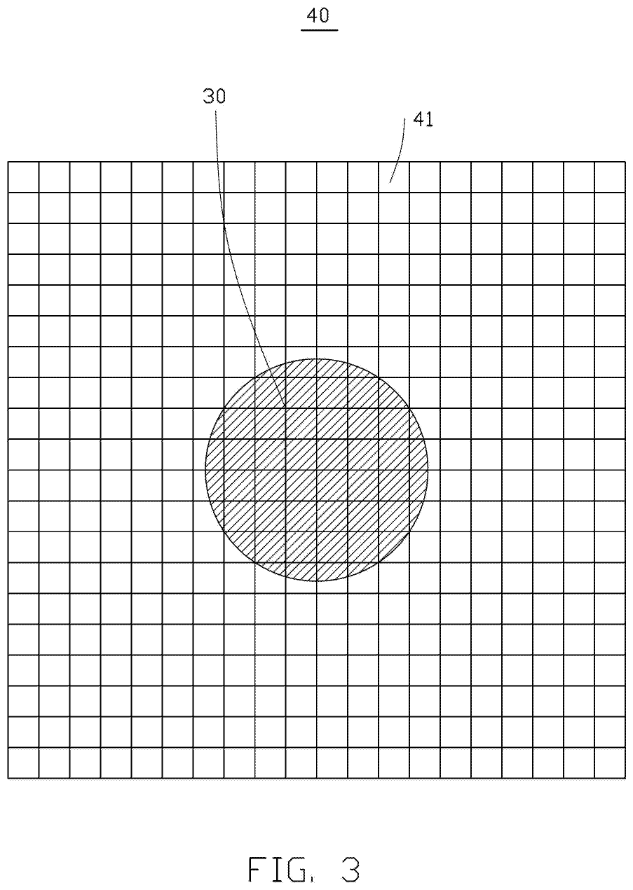

The collimator 10 is used to form a light spot 30 (shown in FIG. 3) on the sensor 40.

The collimator 10 includes a light source 11 and a collimating lens 12 facing the light source 11. Light emitted by the light source 11 is converted into parallel by the collimating lens 12.

The feedback control platform 20 moves in the X-Y direction and selectively tilts in the Z direction.

In at least one embodiment, the feedback control platform 20 includes a moving assembly 21 and at least three tilt adjusting elements 22. The tilt adjusting elements 22 are fixed and distributed on the moving assembly 21 at equal intervals. The moving assembly 21 drives the tilt adjusting elements 22 to move in the X direction or in the Y direction. The lens barrel 70 is fixed on the tilt adjusting elements 22. The tilt adjusting elements 22 drive the lens barrel 70 to selectively tilt in the Z direction.

In at least one embodiment, the moving assembly 21 includes an X-direction slide rail (not shown), a Y-direction slide rail (not shown), and a slider (not shown) slidably connected to the X-direction slide rail and the Y-direction slide rail. The tilt adjusting elements 22 are respectively fixed on the slider. In at least one embodiment, the slider may be mechanically connected to the X-direction slide rail and the Y-direction slide rail by a buckle, or may be adsorbed on the X-direction slide rail and the Y-direction slide rail by a magnet. The slider may be slid non-linearly or linearly on the X-direction slide rail and Y-direction slide rail.

In at least one embodiment, each of the tilt adjusting elements 22 may be made of piezoelectric material. When a voltage flows through the tilt adjusting element 22, the tilt adjusting element 22 deforms at a specified position according to the flowing voltage, thereby driving the lens barrel 70 on the tilt adjusting elements 22 to selectively tilt in the Z direction.

In at least one embodiment, each of the tilt adjusting elements 22 may be a telescopic element. When receiving a telescopic instruction from the processor 60, the tilt adjusting element 22 at the specified position extends or retracts for a specified distance, thereby driving the lens barrel 70 on the tilt adjusting elements 22 to selectively tilt in the Z direction.

In another embodiment, the type of the tilt adjusting element 22 is not limited to the above-mentioned examples, as long as the lens barrel 70 can be selectively tilted.

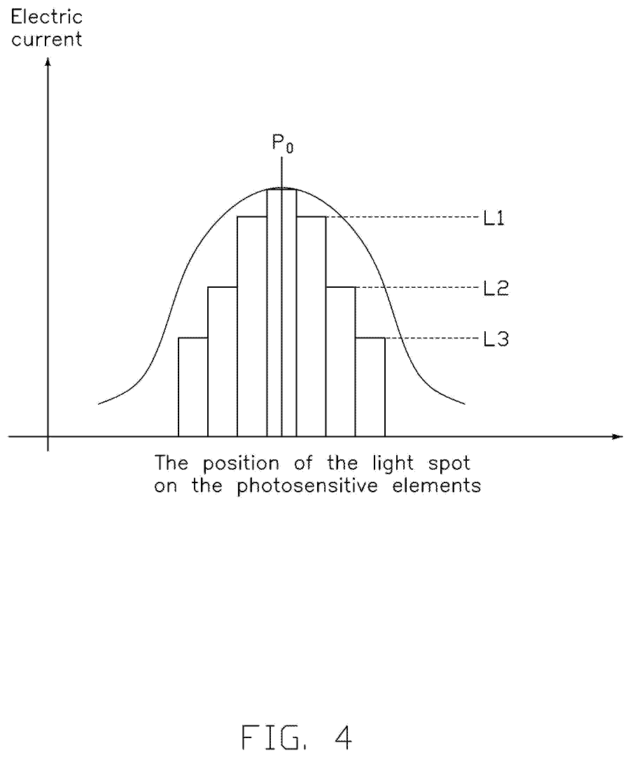

Referring to FIGS. 3 and 4, the sensor 40 is used to calculate a center of the light spot 30 formed on the sensor 40 by a weighted average algorithm.

A center of an initial light spot directly formed by the collimator 10 on the sensor 40 is defined as P₀. A center of the light spot formed on the sensor 40 after passing through n lenses 80 is defined as Pₙ, where n is a positive integer and greater than 0.

In at least one embodiment, the sensor 40 includes a plurality of photosensitive elements 41. The plurality of photosensitive elements 41 are arranged in an array.

In at least one embodiment, the sensor 40 may be plate-shaped or spherical.

In at least one embodiment, the array formed by the plurality of photosensitive elements 41 is spherical. A spherical surface of the array formed by the plurality of photosensitive elements 41 takes a focal point of light after passing through the lenses 80 as a center, and a distance from the sensor 40 to the focal point as a radius. In this way, the light spot may be made into a perfect circle, thereby improving a calculation accuracy of the center of the light spot.

The lens transfer component 50 is used to put the lenses 80 into the lens barrel 70 and drive each of the lenses 80 in the lens barrel 70 to rotate.

In at least one embodiment, the lens transfer component 50 may include a suction nozzle.

In at least one embodiment, the lens transfer component 50 may be a mechanical arm.

The processor 60 is used to receive position information of the center points P₀ and Pₙ sent by the sensor 40, then control the moving assembly 21 to move in the X direction or in the Y direction, control the tilt adjusting elements 22 to selectively tilt in the Z direction, and/or control the lens transfer component 50 to rotate, thereby adjusting a positional relationship between the lenses 80 and the lens barrel 70 until the center P₀ coincides with the center Pₙ or a distance between the center P₀ and the center Pₙ is within an acceptable deviation range.

The collimator 10, the lenses 80, and the sensor 40 meet the following conditions:

D=d*L/F, and L>F.

Where F denotes a focal length of parallel light emitted from the collimator 10 after passing through the lenses 80. L denotes a distance from the sensor 40 to the focal point of the parallel light after passing through the lenses 80. d denotes an eccentricity or inclination between two adjacent lenses 80. D denotes a distance from the center of the light spot formed in the sensor 40 to an optical axis OO′ of the lenses 80.

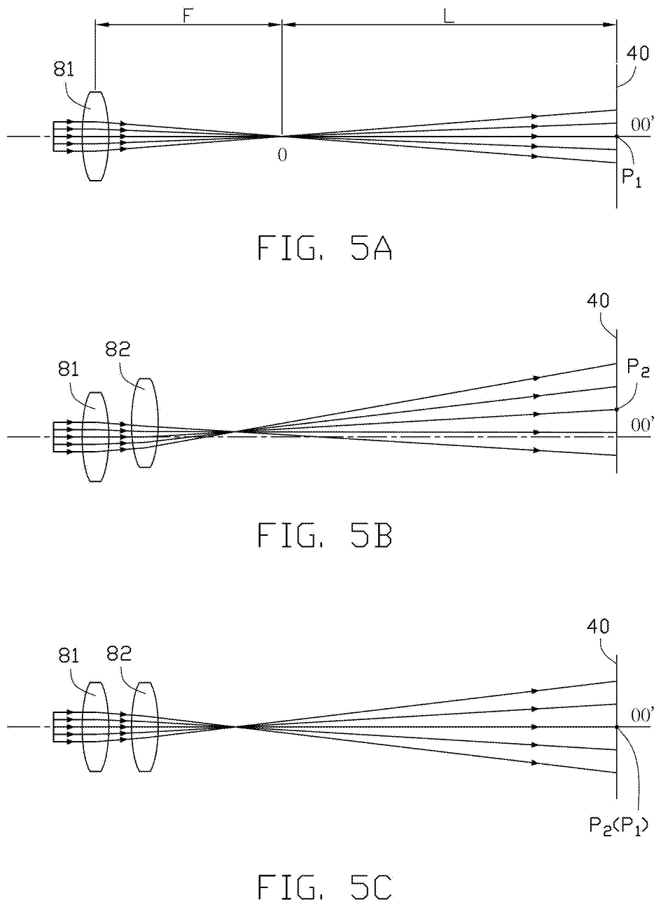

Referring to FIGS. 5A, 5B, and 5C, an application principle of the lens assembling device 100 is illustrated by taking parallel light passing through a first lens 81 and a second lens 82 as an example. Where, a focal point of the parallel light after passing through the first lens 81 or after passing through the first lens 81 and the second lens 82 is defined as O. A focal length of the parallel light after passing through the first lens 81 or after passing through the first lens 81 and the second lens 82 is defined as F. An eccentricity or inclination between the first lens 81 and the second lens 82 is defined as d. An optical axis of the lenses 80 is defined as OO′. A center of a light spot formed on the sensor 40 after passing through the first lens 81 is defined as P₁. A center of a light spot formed on the sensor 40 after passing through the first lens 81 and the second lens 82 is defined as P₂. A distance from the center P₁ to the optical axis OO′ or a distance from the center P₂ to the optical axis OO′ are respectively defined D. In this way, the eccentricity or inclination may be magnified to a suitable multiple through the lens effect, and the distance from the center Pₙ to the optical axis OO′ may be controlled through an active feedback control of the feedback control platform 20 and the lens transfer component 50. So that an optimal angle combination between two lenses 80 may be easily found, so as to ensure a quality of the lens module.

In at least one embodiment, referring to FIG. 5A, when the parallel light enters the first lens 81 perpendicularly, the center P₁ of the light spot formed on the sensor 40 is on the optical axis OO′.

In at least one embodiment, referring to FIG. 5B, the first lens 81 and the second lens 82 are eccentric or the second lens 82 is inclined with respect to the first lens 81. In this embodiment, a center of the second lens 82 is deviated upward from a center of the first lens 81. When the parallel light enters the first lens 81 and the second lens 82 in that sequence, the center P₂ of the light spot formed on the sensor 40 is above the optical axis OO′. The distance between the center P₂ and the center P₁ is the distance D from the center P₂ to the optical axis OO′. When L>F, the eccentricity or inclination d may be enlarged to an appropriate multiple. In at least one embodiment, the eccentricity or inclination d may be magnified up to 100 times.

In at least one embodiment, referring to FIG. 5C, the feedback control platform 20 is controlled to move in the X direction and/or in the Y direction, the feedback control platform 20 is controlled to selectively tilt in the Z direction, and/or the lens transfer component 50 is controlled to rotate, so that the center P₂ coincides with the center P₁ or the distance between the center P₂ and the center P₁ is infinitely close to within an acceptable deviation range. A best angle combination of each lens 80 may be found when assembling the lenses 80 in the lens barrel 70, so as to ensure a better quality of the lens module.

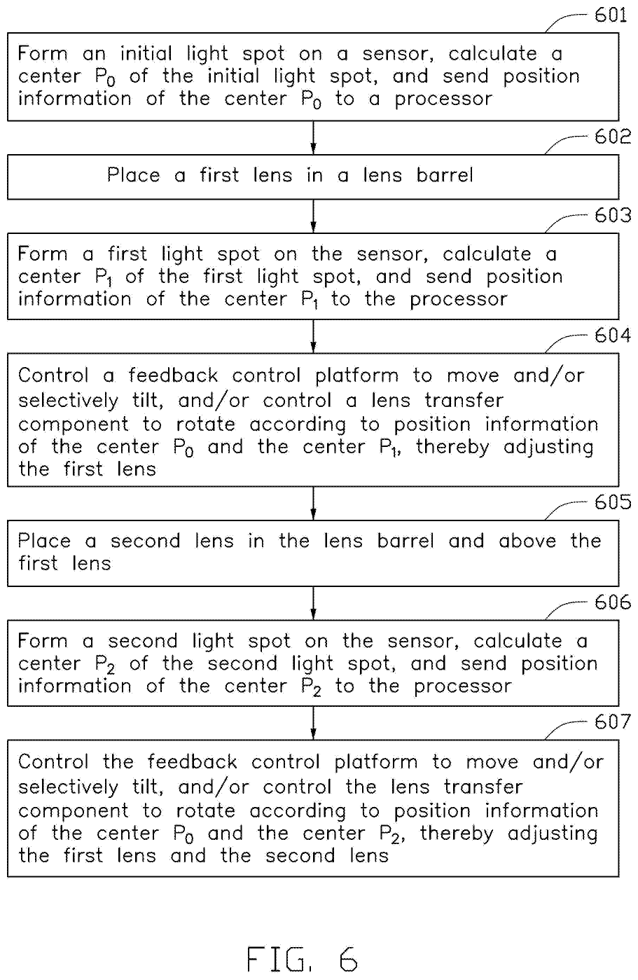

FIG. 6 illustrates a flowchart of a method in accordance with an embodiment. The method for assembling lenses by the lens assembling device 100 is provided by way of embodiments, as there are a variety of ways to carry out the method. Each block shown in FIG. 6 represents one or more processes, methods, or subroutines carried out in the method. Furthermore, the illustrated order of blocks can be changed. Additional blocks may be added or fewer blocks may be utilized, without departing from this disclosure. The method can begin at block 601.

At block 601, an initial light spot is formed on the sensor 40 by light emitted from the collimator 10. A center P₀ of the initial light spot is calculated by the weighted average algorithm after grading an initial electric current generated on the sensor 40. Position information of the center P₀ is sent to the processor 60.

At block 602, a first lens 81 is clamped to be placed in the lens barrel 70 by the lens transfer component 50.

At block 603, a first light spot is formed on the sensor 40 by light emitted from the collimator 10 after passing through the first lens 81. A center P₁ of the first light spot is calculated by the weighted average algorithm after grading a first electric current generated on the sensor 40. Position information of the center P₁ is sent to the processor 60.

At block 604, the processor 60 according to the position information of the center P₀ and the center P₁ controls the feedback control platform 20 to move in at least of the X direction and the Y direction, controls the feedback control platform 20 to selectively tilt in the Z direction, and/or controls the lens transfer component 50 to rotate, to drive the first lens 81 until the center P₀ coincides with the center P₁ or a distance between the center P₀ and the center P₁ is within an acceptable deviation range.

At block 605, a second lens 82 is clamped to be placed in the lens barrel 70 and above the first lens 81 by the lens transfer component 50.

At block 606, a second light spot is formed on the sensor 40 by light emitted from the collimator 10 after passing through the first lens 81 and the second lens 82 in that sequence. A center P₂ of the second light spot is calculated by the weighted average algorithm after grading a second electric current generated on the sensor 40. Position information of the center P₂ is sent to the processor 60.

At block 607, the processor 60 according to a positional relationship between the center P₀ and the center P₂ controls the feedback control platform 20 to move in at least of the X direction and the Y direction, controls the feedback control platform 20 to selectively tilt in the Z direction, and/or controls the lens transfer component 50 to rotate, to drive the second lens 82 and the first lens 81 until the center P₀ coincides with the center P₂ or a distance between the center P₀ and the center P₂ is within an acceptable deviation range.

In at least one embodiment, after the block 607, the method for assembling the lenses by the lens assembling device 100 may further includes assembling other lenses in the lens barrel 70 and above the second lens 82, calculating position information of a center Pₙ of a light spot after passing all of the lenses in the lens barrel 70, sending the position information of the center Pₙ to the processor 60, then driving all of the lenses in the lens barrel 70 by the processor 60 according to a positional relationship between the center P₀ and the center Pₙ until the center P₀ coincides with the center Pₙ or a distance between the center P₀ and the center Pₙ is within an acceptable deviation range.

The lens assembling device 100 and the method for assembling the lenses by the lens assembling device 100 may reduce a time cost of analysis and correction after lens combination and a difficulty of a quality detection of a lens module assembled by the lenses and lens barrel.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. A lens assembling device configured to assemble a plurality of lenses in a lens barrel to form a lens module, the lens assembling device comprising:
a collimator configured to form a light spot;
a sensor configured to calculate a center of the light spot formed on the sensor by a weighted average algorithm, wherein a center of an initial light spot directly formed by the collimator on the sensor is defined as P₀, a center of a light spot formed on the sensor after passing through n lenses in the lens barrel is defined as Pₙ, n is a positive integer and greater than 0;
a feedback control platform located between the collimator and the sensor;
a lens transfer component configured to put each of the plurality of lenses into the lens barrel and drive each of the plurality of lenses in the lens barrel to rotate; and
a processor electrically or signal connected to the feedback control platform, the sensor, and the lens transfer component, respectively; wherein the processor is configured to receive position information of the center P₀ and the center Pₙ sent by the sensor, control the feedback control platform to move in a X direction or in a Y direction, control the feedback control platform to selectively tilt in a Z direction, and/or control the lens transfer component to rotate, until the center P₀ coincides with the center Pₙ or a distance between the center P₀ and the center Pₙ is within an acceptable deviation range.

2. The lens assembling device of claim 1, wherein the sensor comprises a plurality of photosensitive elements, and the plurality of photosensitive elements is arranged in an array.

3. The lens assembling device of claim 2, wherein the array is spherical, a spherical surface of the array is centered on a focal point of light after passing through the plurality of lenses, and a distance from the sensor to the focal point is defined as a radius.

4. The lens assembling device of claim 1, wherein the feedback control platform comprises a moving assembly and at least three tilt adjusting elements, the at least three tilt adjusting elements are fixed and distributed on the moving assembly at equal intervals to be configured to fix the lens barrel.

5. The lens assembling device of claim 4, wherein the processor is electrically or signal connected to the moving assembly and the at least three tilt adjusting elements, respectively.

6. The lens assembling device of claim 5, wherein the processor is configured to control the moving assembly to move in the X direction or in the Y direction, and control the at least three tilt adjusting elements to selectively tilt in the Z direction.

7. The lens assembling device of claim 4, wherein each of the at least three tilt adjusting elements is made of piezoelectric material.

8. A method for assembling lenses by a lens assembling device, the method comprising:
providing the lens assembling device configured to assemble a plurality of lenses in a lens barrel to form a lens module, the lens assembling device comprising:
a collimator configured to form a light spot;
a sensor configured to calculate a center of the light spot formed on the sensor by a weighted average algorithm, wherein a center of an initial light spot directly formed by the collimator on the sensor is defined as P₀, a center of a light spot formed on the sensor after passing through n lenses in the lens barrel is defined as Pₙ, n is a positive integer and greater than 0;
a feedback control platform located between the collimator and the sensor;
a lens transfer component configured to put each of the plurality of lenses into the lens barrel and drive each of the plurality of lenses in the lens barrel to rotate; and
a processor electrically or signal connected to the feedback control platform, the sensor, and the lens transfer component, respectively; wherein the processor is configured to receive position information of the center P₀ and the center Pₙ sent by the sensor, control the feedback control platform to move in a X direction or in a Y direction, control the feedback control platform to selectively tilt in a Z direction, and/or control the lens transfer component to rotate, until the center P₀ coincides with the center Pₙ or a distance between the center P₀ and the center Pₙ is within an acceptable deviation range;
forming the initial light spot on the sensor by light emitted from the collimator, calculating the center P₀ of the initial light spot by the weighted average algorithm after grading an initial electric current generated on the sensor, and sending the position information of the center P₀ to the processor;
placing a first lens in the lens barrel by the lens transfer component;
forming a first light spot on the sensor by light emitted from the collimator after passing through the first lens, calculating a center P₁ of the first light spot by the weighted average algorithm after grading a first electric current generated on the sensor, and sending position information of the center P₁ to the processor;
controlling the feedback control platform to move in at least of the X direction and the Y direction, controlling the feedback control platform to selectively tilt in the Z direction, and/or controlling the lens transfer component to rotate according to the position information of the center P₀ and the center P₁, thereby driving the first lens until the center P₀ coincides with the center P₁ or a distance between the center P₀ and the center P₁ is within the acceptable deviation range;
placing a second lens in the lens barrel and above the first lens by the lens transfer component;
forming a second light spot on the sensor by light emitted from the collimator after passing through the first lens and the second lens in that sequence, calculating a center P₂ of the second light spot by the weighted average algorithm after grading a second electric current generated on the sensor, and sending position information of the center P₂ to the processor;
controlling the feedback control platform to move in at least of the X direction and the Y direction, controlling the feedback control platform to selectively tilt in the Z direction, and/or controlling the lens transfer component to rotate according to the position information of the center P₀ and the center P₂, thereby driving the first lens and the second lens until the center P₀ coincides with the center P₂ or a distance between the center P₀ and the center P₂ is within the acceptable deviation range.

9. The method of claim 8, wherein the sensor comprises a plurality of photosensitive elements, and the plurality of photosensitive elements is arranged in an array.

10. The method of claim 9, wherein the array is spherical, a spherical surface of the array is centered on a focal point of light after passing through the plurality of lenses, and a distance from the sensor to the focal point is defined as a radius.

11. The method of claim 8, wherein the feedback control platform comprises a moving assembly and at least three tilt adjusting elements, the at least three tilt adjusting elements are fixed and distributed on the moving assembly at equal intervals to be configured to fix the lens barrel.

12. The method of claim 11, wherein the processor is electrically or signal connected to the moving assembly and the at least three tilt adjusting elements, respectively.

13. The method of claim 12, wherein the processor is configured to control the moving assembly to move in the X direction or in the Y direction, and control the at least three tilt adjusting elements to selectively tilt in the Z direction.

14. The method of claim 11, wherein each of the at least three tilt adjusting elements is made of piezoelectric material.
